(19) United States
(12) Patent Application Publication
(10) Pub. No.: US 2013/0213544 A1
(43) Pub. Date: Aug. 22, 2013

(54) TIRE INNER TUBE

(71) Applicant: David QUESADA, Vigo (ES)

(72) Inventor: David QUESADA, Vigo (ES)

(21) Appl. No.: 13/398,894

(22) Filed: Feb. 17, 2012

(51) Int. Cl. B60C 5/00

(52) U.S. Cl. 152/450

(57) ABSTRACT

A tire inner tube primarily includes an inner tube body being a hose having two closed ends and a charging air inlet being positioned at an inner side of the inner tube body, wherein the closed ends of the inner tube body are configured to be removably combined and form the inner tube body into a closed loop that fits a tire rim of a bicycle, so that the tire inner tube is allowed to be mounted around or demounted from the tire rim without removing the tire rim from the bicycle.

### BACKGROUND OF THE INVENTION

1. Technical Field The present invention relates to tires of bicycles, and more particularly, to a tire inner tube that can be replaced without dismounting the whole wheel from a bicycle.

2. Description of Related Art

As known, a typical bicycle wheel is composed of a tire rim, a hollow inner tube mounted around the tire rim and a circular tire wrapping the inner tube. The tire inner tube is usually provided with a charging air inlet from which air is filled into the inner tube and in turn inflates the entire tire.

Since the tire rim is rotatably fixed to a bicycle frame, for replacing the installed inner tube with a new one, the tire rim has to be dismounted from the bicycle frame first and then the inner tube can be removed from the tire rim. After replacement, the tire rim together with the tire has to be assembled to the bicycle frame again. This makes tire replacement a time-consuming and energy-consuming work. As a rear wheel of a bicycle is combined with various transmission mechanisms, replacing the inner tube of a rear wheel is even more difficult and troublesome. When such an inner tube is broken during a bicycle race, the time consumed by the replacement operation can be a negative factor to the race result.

### SUMMARY OF THE INVENTION

One objective of the present invention is to provide a tire inner tube that overcomes the shortcomings of the conventional device.

According to the present invention, the tire inner tube primarily includes an inner tube body being a hose having two closed ends and a charging air inlet being positioned at an inner side of the inner tube body, wherein the closed ends of the inner tube body are configured to be removably combined and form the inner tube body into a closed loop that fits a tire rim of a bicycle, so that the tire inner tube is allowed to be mounted around or demounted from the tire rim without removing the tire rim from the bicycle.

The inner tube body is a hose that is flexible before inflation, so it can be mounted around the tire rim and formed as a closed loop by combining the two closed ends, without removing the entire wheel from the bicycle frame. Also, the disclosed tire inner tube can be removed by simply separating the two closed ends of the deflated inner tube body and drawing the inner tube body out of the groove of the tire rim. Thus, the installation and removal of the disclosed tire inner tube is simple and convenient and can be done rapidly.

In addition, since the closed ends are provided with the complementary inclined surfaces and the inner tube body is slightly curvy, when the inner tube body is inflated by pressurized air through the charging air inlet, the inner tube body can expand into a closed loop and the two closed ends can be joined at their complementary inclined surfaces, so that the joint between the two closed ends of the inner tube body tends to be smooth.

### BRIEF DESCRIPTION OF THE DRAWINGS

The invention as well as a preferred mode of use, further objectives and advantages thereof will be best understood by reference to the following detailed description of illustrative embodiments when read in conjunction with the accompanying drawings, wherein:

FIG. 1 is a perspective view of a tire inner tube according to the present invention;

FIG. 2 is another perspective view of the tire inner tube;

FIG. 3 and FIG. 4 illustrates installation of the tire inner tube; and

FIG. 5 is an applied view of the tire inner tube.

### DETAILED DESCRIPTION OF THE INVENTION

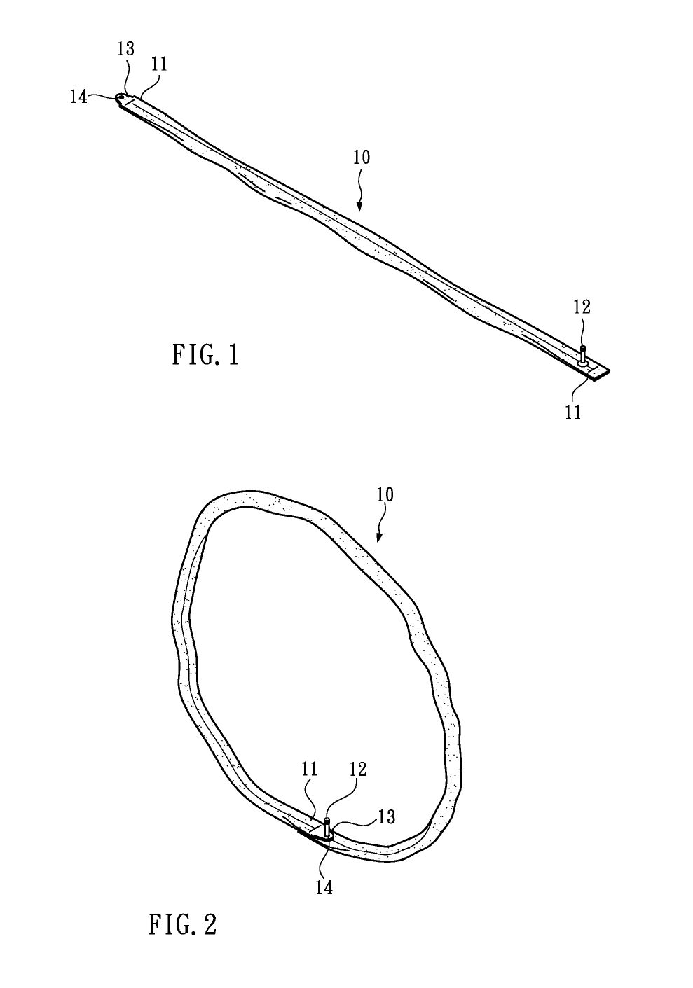

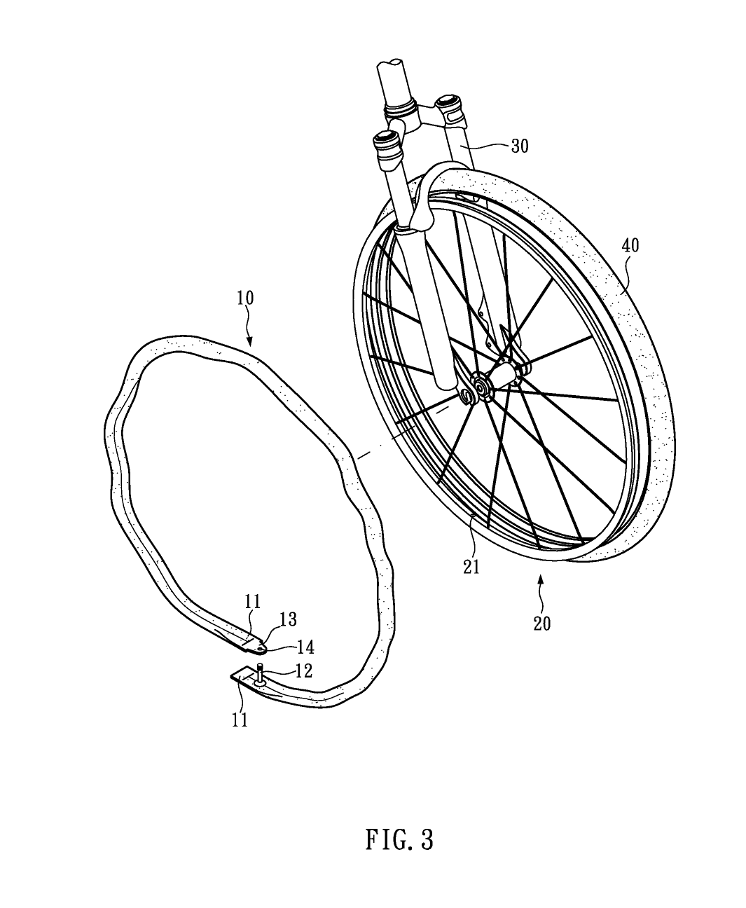

Referring to FIG. 1 and FIG. 2, according to the present invention, a tire inner tube primarily comprises an inner tube body 10. The inner tube body 10 is slightly curvy and formed as a hose that is configured to be curved into a close loop. The inner tube body 10 has its both ends 11 closed. Each of the closed ends 11 has an inclined surface that is configured to be complementarily combined with the inclined surface of the other closed end 11.

The inner tube body 10 further includes a charging air inlet 12 positioned at its inner side near one of the closed ends 11, while having a combining portion 13 at the other closed end 11. The combining portion 13 is formed with a through hole that allows the charging air inlet 12 to pass therethrough and combine therewith.

Basing on the foregoing configuration, the operation of the disclosed tire inner tube will be described in detail below.

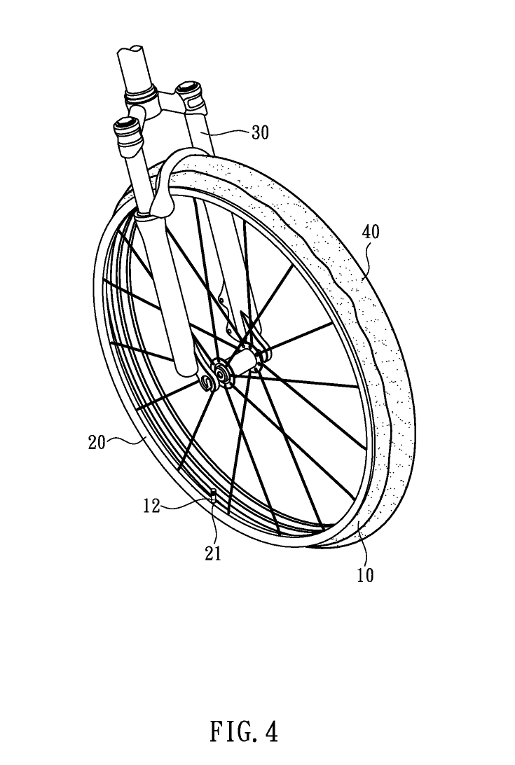

A normal tire rim 20, as shown in FIG. 3, has a charging hole 21. A tire 40 is mounted around the tire rim 20 that is later assembled to a bicycle frame 30. For installing the inner tube body 10, the tire 40 is first pushed away from the tire rim 20 so as to expose a groove formed peripherally on the tire rim 20, and then the inner tube body 10 is put in the groove of the tire rim 20 after passing through the bicycle frame 30, as shown in FIG. 4. Afterward, the charging air inlet 12 is inserted into the through hole 14 formed on the combining portion 13 of the other closed end 11 and then made project from the charging hole 21 of the tire rim 20, thereby fixing the inner tube body 10 to the tire rim 20. After the tire 40 is mounted around the combination of the tire rim 20 and the inner tube body 10, the installation is finished.

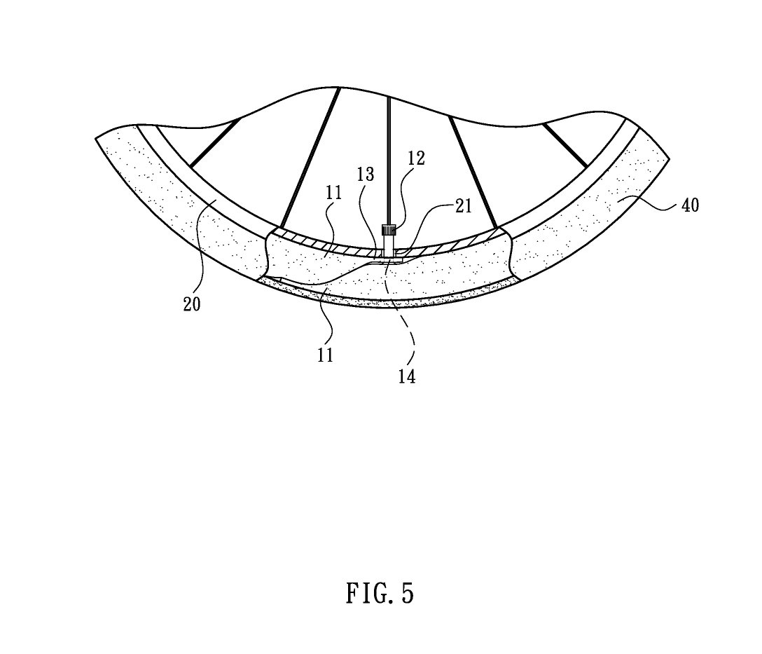

Referring to FIG. 5, since the two closed ends 11 have the inclined surfaces and the inner tube body 10 is slightly curvy, when inflated, the inner tube body 10 can expand into a closed loop that clings to the tire rim 20. At the same time, the two closed ends 11 are also inflated and tightly combined with each other, so the joint therebetween tends to be smooth. The combination of the charging air inlet 12 and the through hole 14 remains the inner tube body 10 in the shape of the closed loop, while the combination of the charging air inlet 12 and the charging hole 21 retains the inner tube body 10 in position. After inflation of the inner tube body 10, the combining portion 13 provides a resilient tension to make the two closed ends 11 closely joined.

The disclosed tire inner tube can be easily removed from the tire rim 20 by deflating the inner tube body 10, pushing the tire 40 away from the tire rim 20, removing the charging air inlet 12 from the charging hole 21 and the through hole 14 of the combining portion 13, and taking the inner tube body 10 away from the bicycle frame 30.

The inner tube body 10 is a hose that is flexible before inflation, so it can be mounted around the tire rim 20 as a closed loop by combining the two closed ends 11, without removing the entire wheel from the bicycle frame 30. Also, the disclosed tire inner tube can be removed by simply separating the two closed ends 11 of the deflated inner tube body 10 and drawing the inner tube body 10 out of the groove of the tire rim 20. Thus, the installation and removal of the disclosed tire inner tube is simple and convenient and can be done rapidly.

In addition, since the closed ends 11 are provided with the complementary inclined surfaces and the inner tube body 10 is slightly curvy, when the inner tube body 10 is inflated by pressurized air through the charging air inlet 12, the inner tube body 10 can expand into a closed loop and the two closed ends 11 can be joined at their matching inclined surfaces, so that the joint between the two closed ends 11 of the inner tube body 10 tends to be smooth.

Moreover, the inner tube body 10 is a strip-like component so it is easier to store and carry as compared to the conventional circular inner tube.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A tire inner tube comprising:
an inner tube body being a hose having two closed ends; and
a charging air inlet being positioned at an inner side of the inner tube body, wherein the closed ends of the inner tube body are configured to be removably combined and form the inner tube body into a closed loop that fits a tire rim of a bicycle, so that the tire inner tube is allowed to be mounted around or demounted from the tire rim without removing the tire rim from the bicycle.

2. The tire inner tube of claim 1, wherein each of the closed ends has an inclined surface so that the two closed ends are allowed to be fittingly combined with each other.

3. The tire inner tube of claim 1, wherein the inner tube body is slightly curvy so as to facilitate forming the closed loop.

4. The tire inner tube of claim 1, wherein the charging air inlet is positioned near one of the closed ends of the inner tube body.

5. The tire inner tube of claim 4, wherein a combining portion is provided at the other closed end.

6. The tire inner tube of claim 5, wherein the combining portion is formed with a through hole that allows the charging air inlet to pass therethrough and combine therewith.
